(19) United States
(12) Patent Application Publication
(10) Pub. No.: US 2026/0337395 A1
(43) Pub. Date: Oct. 29, 2026

(54) RESIN COMPOSITION, METHOD FOR PRODUCING SAME, AND REFRIGERANT TRANSPORTING HOSE

(71) Applicant: THE YOKOHAMA RUBBER CO., LTD., Kanagawa (JP)

(72) Inventor: Kenta WAKABAYASHI, Kanagawa (JP)

(21) Appl. No.: 19/114,704

(22) PCT Filed: Jan. 24, 2023
(86) PCT No.: PCT/JP2023/002123

§ 371 Date: Mar. 24, 2025

(30) Foreign Application Priority Data
Sep. 29, 2022 (JP) 2022-156953
Sep. 29, 2022 (JP) 2022-157013
Oct. 13, 2022 (JP) 2022-164844
Oct. 28, 2022 (JP) 2022-173698
Oct. 28, 2022 (JP) 2022-173703
Oct. 28, 2022 (JP) 2022-173726
Dec. 12, 2022 (WO) PCT/JP2022/045679
Dec. 12, 2022 (WO) PCT/JP2022/045680

(51) Int. Cl. C08L 23/283; B32B 1/08; B32B 5/02; B32B 25/10; B32B 25/18; C08K 3/22; C08L 23/22; C08L 23/28; F16L 11/08

(52) U.S. Cl. CPC C08L 23/283; B32B 1/08; B32B 5/024; B32B 25/10; B32B 25/18; C08K 3/22; C08L 23/22; C08L 23/28; F16L 11/085; B32B 2305/72; B32B 2307/54; B32B 2307/7246; B32B 2597/00; C08K 2003/2296; C08L 2205/025; C08L 2205/03; C08L 2205/035; C08L 2312/04

(57) ABSTRACT

A resin composition contains a matrix containing a resin, and a domain containing a rubber, the resin composition containing a rubber crosslinking agent, and in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, is 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, satisfy: S′_{10 min, 200° C.}/S′_{MAX, 200° C.}≥0.9, and S′_{10 min, 230° C.}/S′_{MAX, 230° C.}≥0.9.

### TECHNICAL FIELD

The present technology relates to a resin composition, a method for producing the same, and a refrigerant-transporting hose. The present technology more particularly relates to a resin composition having excellent heat resistance and water vapor barrier properties that can be used for production of a refrigerant-transporting hose used for an air conditioner of an automobile, a method for producing the resin composition, and a refrigerant-transporting hose produced by using the resin composition.

### BACKGROUND ART

With the increasing demand for weight reduction of automobiles, efforts have been made to achieve the weight reduction by producing a hose, which has been used for automobiles and is made of a rubber, with a resin having high barrier properties in place of a rubber to reduce thickness. In particular, a main material for a refrigerant-transporting hose for current automobile air conditioners is rubber, and if the main material can be substituted with a resin having high barrier properties, weight reduction can be achieved.

Japan Unexamined Patent Publication No. H04-145284 A describes a hose for transportation of a refrigerant such as Freon gas, an outer tube of the hose being made of a thermoplastic elastomer containing a thermoplastic polyolefin resin and EPDM (ethylene propylene diene monomer) or a butyl rubber.

Air conditioners of automobiles and the like are installed in limited, narrow spaces in automobiles, and thus excellent flexibility and easy installation even in narrow spaces are required for refrigerant-transporting hoses. Permeation of water vapor from a hose outer side causes freezing of moisture inside an air conditioner, and thus a material forming an outer tube of the refrigerant-transporting hose is required to have excellent water vapor barrier properties. Furthermore, the refrigerant-transporting hose needs to be durable enough to withstand long-term use in the high-temperature and high-humidity environment inside an engine room.

However, because a thermoplastic elastomer constituting an outer tube of a resin hose described in Japan Unexamined Patent Publication No. H04-145284 A contains a thermoplastic polyolefin resin, heat resistance is not necessarily sufficient.

### SUMMARY

The present technology provides a resin composition that can be used for producing an outer tube of a resin hose and that has excellent heat resistance and water vapor barrier properties.

An aspect of the present technology (I) is a resin composition characterized by containing a matrix containing a resin, and a domain containing a rubber; the resin composition containing a rubber crosslinking agent; and in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, being 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, satisfying: S′_{10 min, 200° C.}/S′_{MAX, 200° C.}≥0.9, and S′_{10 min, 230° C.}/S′_{MAX, 230° C.}≥0.9.

An aspect of the present technology (II) is a method for producing a resin composition containing a matrix containing a resin, and a domain containing a rubber;

the method is characterized by including melt-kneading a resin, a rubber, and a rubber crosslinking agent, and in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, is 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, satisfy: S′_{10 min, 200° C.}/S′_{MAX, 200° C.}≥0.9, and S′_{10 min, 230° C.}/S′_{MAX, 230° C.}≥0.9.

An aspect of the present technology (III) is a refrigerant-transporting hose characterized by including an inner layer, a reinforcing layer, and an outer layer, the outer layer containing the resin composition described in the aspect of the present technology (I).

The present technology includes the following embodiments.
[1] A resin composition containing a matrix and a domain, the matrix containing a resin, and the domain containing a rubber; the resin composition containing a rubber crosslinking agent; and in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, being 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, satisfying: S′_{10 min, 200° C.}/S′_{MAX, 200° C.}≥0.9, and S′_{10 min, 230° C.}/S′_{MAX, 230° C.}≥0.9. [2] The resin composition according to [1], where a water vapor permeability of a resin is 3.0 g·mm/(m²·24 h) or less.
[3] The resin composition according to [1] or [2], where a water vapor permeability of a rubber is 3.0 g·mm/(m²·24 h) or less.
[4] The resin composition according to any one of [1] to [3], where a rubber has a polyisobutylene backbone.
[5] The resin composition according to any one of [1] to [4], where a rubber crosslinking agent contains zinc oxide and an alkylphenol-formaldehyde resin.
[6] The resin composition according to any one of [1] to [5], where a resin is a polyolefin resin.
[7] The resin composition according to any one of [1] to [6], where a resin contains a silane-modified polyolefin resin.
[8] The resin composition according to [7], where a resin composition contains a silanol condensation catalyst.
[9] The resin composition according to any one of [1] to [8], where a tensile strength at 150° C. of a resin composition is 1.5 MPa or more.
[10] The resin composition according to any one of [1] to [9], where a water vapor permeability of a resin composition is 3.0 g·mm/(m²·24 h) or less.
[11] The resin composition according to any one of [1] to [10], where a 10% modulus of a resin composition at room temperature is 10 MPa or less.
[12] A method for producing a resin composition containing a matrix and a domain, the matrix containing a resin, and the domain containing a rubber,
the method including melt-kneading a resin, a rubber, and a rubber crosslinking agent,
in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, being 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, satisfying: S′_{10 min, 200° C.}/S′_{MAX, 200° C.}≥0.9, and S′_{10 min, 230° C.}/S′_{MAX, 230° C.}≥0.9.
[13] A refrigerant-transporting hose including an inner layer, a reinforcing layer, and an outer layer, an outer layer containing a resin composition according to any one of [1] to [11].

The resin composition of an embodiment of the present technology has excellent heat resistance and water vapor barrier properties.

### BRIEF DESCRIPTION OF DRAWINGS

FIG. 1 is a cross-sectional view of a refrigerant-transporting hose.

FIG. 2 illustrates torque-time curves of a case where no reversion occurred.

FIG. 3 illustrates torque-time curves of a case where reversion occurred.

### DETAILED DESCRIPTION

The resin composition of an embodiment of the present technology contains a matrix containing a resin, and a domain containing a rubber, and further contains a rubber crosslinking agent.

The resin composition of an embodiment of the present technology is characterized by satisfying that, in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, is 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, have relationships: S′_{10 min, 200° C.}/S′_{MAX, 200° C.}≥0.9, and S′_{10 min, 230° C.}/S′_{MAX, 230° C.}≥0.9.

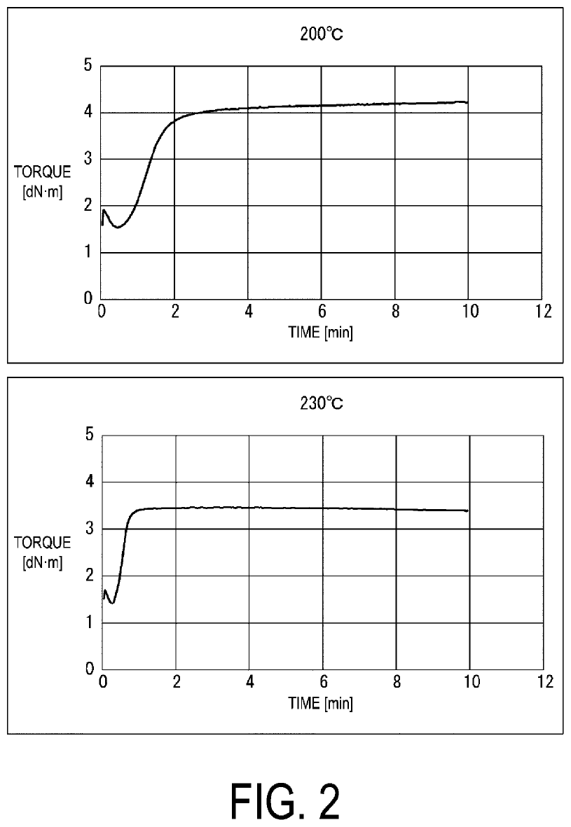

FIG. 2 illustrates torque-time curves obtained by measuring torque over time by using an oscillating curemeter when a rubber kneaded material obtained by kneading a rubber and a rubber crosslinking agent of Example 1 was heated at 200° C. or at 230° C. for 10 minutes. In the torque-time curve for 200° C., no local maximum value of torque is observed before 10 minutes have passed. A case where no local maximum value of torque is observed before 10 minutes have passed is referred to as “no reversion occurred”, that is, “no reversion of crosslinking occurred”. If no reversion occurred, strength during heating is good. Specifically, a tensile strength at 150° C. is large.

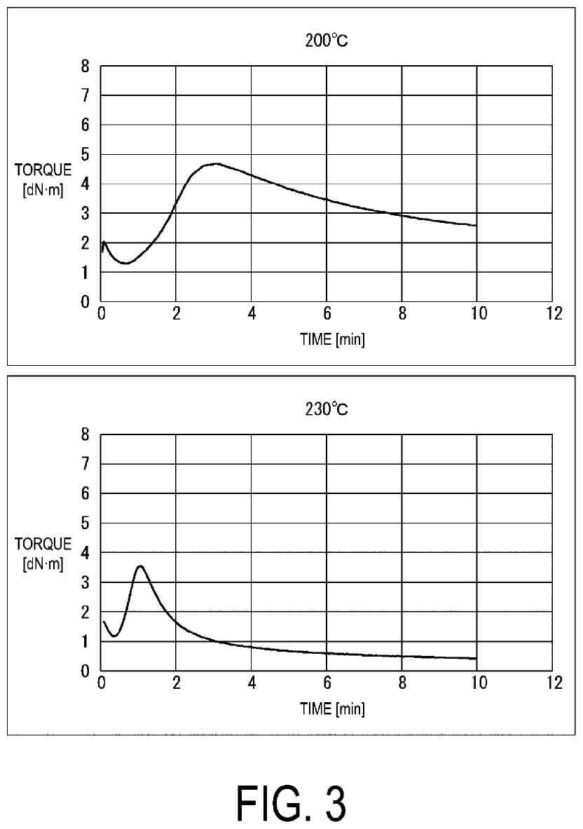

FIG. 3 illustrates torque-time curves obtained by measuring torque over time by using an oscillating curemeter when a rubber kneaded material obtained by kneading a rubber and a rubber crosslinking agent of Comparative Example 1 was heated at 200° C. or at 230° C. for 10 minutes. In these torque-time curves, a local maximum value S′_{MAX} of torque is observed before 10 minutes have passed. A case where a local maximum value of torque is observed before 10 minutes has passed is referred to as “reversion occurred”, that is, “reversion of crosslinking occurred”. When the reversion occurred and the torque S′_{10 min} after 10 minutes is significantly smaller than S′_{MAX}, the strength during heating is poor, specifically, a tensile strength at 150° C. is small.

In the torque-time curves, the resin composition of an embodiment of the present technology has torque after 10 minutes at 200° C., S′_{10 min, 200° C.}, of 3.0 dN·m or more, preferably from 3.1 to 20.0 dN·m, and more preferably from 3.2 to 15.0 dN·m. When S′_{10 min, 200° C.} is in this numerical range, excellent heat resistance, i.e., strength during heating, is achieved and, specifically, the tensile strength at 150° C. is large.

In the torque-time curve, the resin composition of an embodiment of the present technology has: S′_{10 min, 200° C.}; torque after 10 minutes at 230° C., S′_{10 min, 230° C.}; a maximum value of torque for 0 to 10 minutes at 200° C., S′_{MAX, 200° C.}; and a maximum value of torque for 0 to 10 minutes at 230° C., S′_{MAX, 230° C.}, satisfying the following relationship (1) and relationship (2).

S′_{10 min, 200° C.}/S′_{MAX, 200° C.}≥0.9 (1)

S′_{10 min, 230° C.}/S′_{MAX, 230° C.}≥0.9 (2)

When the relationship (1) and the relationship (2) are satisfied, the resin composition achieves excellent heat resistance, that is, strength during heating, and, specifically, achieves a large tensile strength at 150° C.

S′_{10 min, 200° C.}/S′_{MAX, 200° C.} is preferably from 0.92 to 1.0, and more preferably from 0.95 to 1.0.

S′_{10 min, 230° C.}/S′_{MAX, 230° C.} is preferably from 0.92 to 1.0, and more preferably from 0.95 to 1.0.

Note that the method of measuring torque over time by using an oscillating curemeter when a rubber kneaded material obtained by kneading a rubber and a rubber crosslinking agent was heated at 200° C. or at 230° C. for 10 minutes can be performed in accordance with “Determination of cure characteristics with oscillating curemeters” in JIS (Japanese Industrial Standard) K 6300-2.

The resin composition contains a matrix containing a resin, and a domain containing a rubber. That is, the resin composition has a sea-island structure, a sea phase includes the resin, and an island phase contains the rubber. When the resin composition has the sea-island structure, a material having thermoplasticity of the resin and flexibility of the rubber is formed.

Examples of the resin constituting the matrix includes, but not limited to, a polyolefin resin, a polyamide resin, a polyester resin, and an ethylene-vinyl alcohol copolymer. Among these, a preferred resin is a polyolefin resin. Examples of the polyolefin resin include polyethylene, polypropylene, a copolymer of ethylene and α-olefin, and a copolymer of propylene and another α-olefin.

The resin constituting the matrix more preferably contains a silane-modified resin. When the matrix contains a silane-modified resin, heat resistance improves.

The silane-modified resin refers to a resin modified with a silane compound. The silane-modified resin is preferably a resin obtained by modifying a polyolefin-based thermoplastic resin with a silane compound, and is more preferably a crosslinkable resin having a hydrolyzable silyl group (preferably an alkoxysilyl group) obtained by modifying a polyolefin-based thermoplastic resin with a silane compound, or a crosslinked resin obtained by crosslinking the crosslinkable resin. In other words, the silane-modified resin is preferably a silane-modified polyolefin resin.

The silane compound is not limited but is preferably a compound represented by Formula (3).

R¹—SiR²ₙY₃₋ₙ (3)

R¹ is an ethylenic unsaturated hydrocarbon group, R² is a hydrocarbon group, Y is a hydrolyzable organic group, and n is an integer of 0 to 2.

R¹ is preferably an ethylenic unsaturated hydrocarbon group having from 2 to 10 carbons, and examples thereof include a vinyl group, a propenyl group, a butenyl group, a cyclohexenyl group, and a γ-(meth)acryloyloxypropyl group.

R² is preferably a hydrocarbon group having from 1 to 10 carbons, and examples thereof include a methyl group, an ethyl group, a propyl group, a decyl group, and a phenyl group.

Y is preferably a hydrolyzable organic group having from 1 to 10 carbons, and examples thereof include an alkoxy group (e.g., a methoxy group, an ethoxy group), a formyloxy group, an acetoxy group, a propionyloxy group, an alkyl amino group, and an arylamino group.

Specific examples of the silane compound include vinyltrimethoxysilane, vinyltriethoxysilane, vinyltriacetoxysilane, and γ-methacryloyloxypropyltrimethoxysilane. Among these, vinyltrimethoxysilane is preferred.

The polyolefin-based thermoplastic resin constituting the silane-modified resin is not limited, and examples thereof include polyethylene, a copolymer of ethylene and α-olefin, polypropylene, and a copolymer of propylene and another α-olefin. Polypropylene and a copolymer of propylene and another α-olefin are preferred, and polypropylene is particularly preferred.

The hydrolyzable silyl group refers to a group generating a silanol group (≡Si—OH) by hydrolysis and is preferably a group represented by Formula (4).

—SiR²ₙY₃₋ₙ (4)

However, R² and Y are as described above.

The crosslinkable resin refers to resin that can undergo a crosslinking reaction but that is not crosslinked yet. The type of crosslinking reaction is not limited and may be a crosslinking by a peroxide but is preferably a crosslinking by moisture (water crosslinking).

The method of modifying with a silane compound is not limited, and examples thereof include grafting and copolymerization. The grafting is a method of adding a silane compound to a resin by a grafting reaction and is more specifically a reaction of generating a carbon radical by cleaving a carbon-hydrogen bonding of polyolefin and adding a silane compound having an ethylenic unsaturated hydrocarbon group to the carbon radical. The modification can be preferably performed by melt-kneading a resin and a silane compound of Formula (3) in the presence of a radical generator, such as an organic peroxide. The copolymerization can be preferably performed by radical copolymerization of a monomer constituting a resin and a silane compound of Formula (3).

The silane-modified resin is preferably silane-modified polypropylene. The silane-modified resin is commercially available, and a commercially available product can be used as a silane-modified resin used for an embodiment of the present technology. Examples of the commercially available product of the silane-modified resin include “Linklon” (trade name) available from Mitsubishi Chemical Corporation.

The resin constituting the matrix may contain a resin other than the silane-modified resin. Examples of the resin other than the silane-modified resin include a polyolefin resin and a polyamide resin. Examples of the polyolefin resin include polypropylene. Blending of the polypropylene in addition to the silane-modified resin forms a phase structure that tends to exhibit strength during heating because the viscosity of the resin component becomes stable. Furthermore, because the water vapor barrier properties of the polypropylene are good, the water vapor barrier properties of the entire composition become good.

The water vapor permeability of the resin is preferably 3.0 g. mm/(m²·24 h) or less, more preferably 2.5 g mm/(m²·24 h) or less, and even more preferably 2.0 g mm/(m²·24 h) or less. When the water vapor permeability of the resin is in the numerical range, water vapor permeation from outside can be prevented when a hose is formed.

The content of the resin is from 10 to 150 parts by mass, preferably from 10 to 100 parts by mass, and more preferably from 10 to 80 parts by mass, with respect to 100 parts by mass of the rubber. When the content of the resin is excessively small, extrudability becomes poor. When the content of the resin is excessively large, flexibility cannot be ensured.

The rubber constituting the domain is not limited as long as the rubber has the S′_{10 min, 200° C.} of 3.0 dN·m or more and satisfies the relationship (1) and the relationship (2).

The rubber constituting the domain is preferably a rubber having a polyisobutylene backbone.

The rubber having a polyisobutylene backbone is not limited as long as the rubber has a polyisobutylene backbone but is preferably a butyl rubber (IIR), a modified butyl rubber, a brominated isobutylene-p-methylstyrene copolymer rubber, or a styrene-isobutylene-styrene block copolymer, and is more preferably a butyl rubber or a modified butyl rubber.

The polyisobutylene backbone refers to a chemical structure formed by polymerization of a plurality of isobutylene, that is, a chemical structure represented by —[—CH₂—C(CH₃)₂—]ₙ— (however, n is an integer of 2 or more).

The butyl rubber refers to an isobutylene-isoprene copolymer obtained by copolymerizing isobutylene and a small amount of isoprene and is abbreviated as IIR. Specific examples of the butyl rubber include the butyl rubber “Exxon Butyl” 268, available from ExxonMobil Chemical Company.

The modified butyl rubber refers to a butyl rubber, in which a double bond, a halogen, and the like are present in an isoprene backbone. As the modified butyl rubber, a halogenated butyl rubber is preferred, a brominated butyl rubber and a chlorinated butyl rubber are more preferred, and a brominated butyl rubber is even more preferred.

A styrene-isobutylene-styrene block copolymer is abbreviated as SIBS.

Use of the rubber having the polyisobutylene backbone improves the water vapor barrier properties of the resin composition.

The rubber having the polyisobutylene backbone is preferably dynamically crosslinked. The dynamic crosslinking improves durability.

The water vapor permeability of the rubber is preferably 3.0 g·mm/(m²·24 h) or less, more preferably 2.5 g mm/(m²·24 h) or less, and even more preferably 2.0 g·mm/(m²·24 h) or less. When the water vapor permeability of the rubber is in the numerical range, the water vapor barrier properties of the resin composition improve.

The resin composition contains a rubber crosslinking agent.

The rubber crosslinking agent is not limited as long as the rubber crosslinking agent has S′_{10 min, 200° C.} of 3.0 dN·m or more and satisfies the relationship (1) and the relationship (2), and examples thereof include zinc oxide and an alkylphenol-formaldehyde resin.

The rubber crosslinking agent preferably contains zinc oxide and an alkylphenol-formaldehyde resin. When the rubber crosslinking agent contains zinc oxide and an alkylphenol-formaldehyde resin, heat resistance that can endure an environment at 150° C. can be imparted to the resin composition.

Zinc oxide is zinc oxide, which is an oxide of zinc represented by the chemical formula ZnO. Zinc oxide is commercially available, and commercially available zinc oxide can be used in an embodiment of the present technology. Examples of a commercially available product include Zinc Oxide III, available from Seido Chemical Industry Co., Ltd.

The alkylphenol-formaldehyde resin refers to a compound represented by Formula (5).

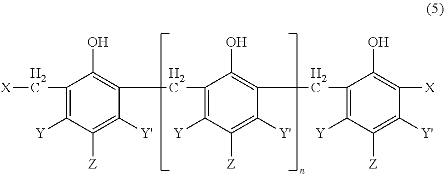

In Formula (5), X is a hydroxyl group or a halogen, Y and Y′ are each hydrogen or an alkyl group, Z is an alkyl group or a halogen, and n is an integer of 0 to 20. The halogens constituting X and Z are each preferably fluorine, chlorine, bromine, or iodine, and more preferably bromine. The alkyl groups constituting Y, Y′, and Z are each preferably an alkyl group having from 1 to 8 carbons.

Although the structural formula represented by Formula (5) is a straight chain, the alkylphenol-formaldehyde resin is synthesized by an ordinary method and may have a branched portion.

Note that one having bromine as X is referred to as a brominated alkylphenol-formaldehyde resin.

Alkylphenol-formaldehyde resins are commercially available, and the commercially available products can be used in an embodiment of the present technology. Examples of the commercially available product include Alkylphenol-formaldehyde resin “Hitanol” (trade name) 2501Y, available from Hitachi Chemical Co., Ltd.

The content of the rubber crosslinking agent is from 2.5 to 25 parts by mass, preferably from 2.5 to 20 parts by mass, and more preferably from 2.5 to 18 parts by mass, with respect to 100 parts by mass of the rubber. When the content of the rubber crosslinking agent is excessively small, dynamic crosslinking of the elastomer is insufficient, and strength during heating decreases. When the content is excessively large, the resin that is the sea phase is affected, and strength during heating decreases.

The content of the zinc oxide is from 1 to 10 parts by mass, preferably from 2 to 8 parts by mass, and more preferably from 3 to 8 parts by mass, with respect to 100 parts by mass of the rubber. When the content of the zinc oxide is excessively small, dynamic crosslinking of the elastomer is insufficient, and strength during heating decreases. When the content is excessively large, the resin that is the sea phase is affected, and strength during heating decreases.

The content of the alkylphenol-formaldehyde resin is from 1.5 to 15 parts by mass, preferably from 1.5 to 10 parts by mass, and more preferably from 2 to 10 parts by mass, with respect to 100 parts by mass of the rubber. When the content of the alkyl phenol formaldehyde resin is excessively small, dynamic crosslinking of the elastomer is insufficient, and strength during heating decreases. When the content is excessively large, the resin that is the sea phase is affected, and strength during heating decreases.

In a case where the resin contains the silane-modified resin, the resin composition preferably contains a silanol condensation catalyst. In the resin composition, the silane-modified resin is crosslinked upon contact with water or water vapor and, when the silanol condensation catalyst is contained, crosslinking of the silane-modified resin is promoted.

Examples of the silanol condensation catalyst include, but not limited to, a metal organic acid salt, a titanate, a borate, an organic amine, an ammonium salt, a phosphonium salt, an inorganic acid, an organic acid, an inorganic acid ester, and a bismuth compound.

Examples of the metal organic acid salt include, but not limited to, dibutyltin dilaurate, dioctyltin dilaurate, dibutyltin diacetate, dibutyltin dioctoate, tin (II) acetate, tin (II) octanoate, cobalt naphthenate, lead octylate, lead naphthenate, zinc octylate, zinc caprylate, iron 2-ethylhexanoate, iron octylate, and iron stearate.

Examples of the titanate include, but not limited to, tetrabutyl titanate, tetranonyl titanate, and bis(acetylacetonitrile) di-isopropyl titanate.

Examples of the organic amine include, but not limited to, ethylamine, dibutylamine, hexylamine, triethanolamine, dimethyl soya amine, tetramethylguanidine, and pyridine.

Examples of the ammonium salt include, but not limited to, ammonium carbonate and tetramethylammonium hydroxide.

Examples of the phosphonium salt include, but not limited to, tetramethylphosphonium hydroxide.

Examples of the inorganic acid include, but not limited to, sulfuric acid and hydrochloric acid.

Examples of the organic acid include, but not limited to, acetic acid, stearic acid, maleic acid, toluenesulfonic acid, and sulfonic acid such as alkylnaphthylsulfonic acid. Examples of the inorganic acid ester include, but not limited to, a phosphoric acid ester.

Examples of the bismuth compound include, but not limited to, an organic bismuth such as bismuth 2-ethylhexanoate.

The silanol condensation catalyst is preferably a metal organic acid salt, sulfonic acid, or a phosphoric acid ester, and more preferably a metal carboxylate of tin such as dioctyltin dilaurate, alkylnaphthylsulfonic acid, and ethylhexyl phosphate. One type of silanol condensation catalyst may be used alone, or two or more types of the silanol condensation catalysts may be appropriately combined and used.

The content of the silanol condensation catalyst is preferably from 0.0001 to 0.5 parts by mass, and more preferably from 0.0001 to 0.3 parts by mass, with respect to 100 parts by mass of the silane-modified resin.

The silanol condensation catalyst is preferably used as a silanol condensation catalyst-containing master batch in which a resin and a silanol condensation catalyst are blended. Examples of the resin that can be used for this silanol condensation catalyst-containing master batch include a polyolefin, and a polyethylene, a polypropylene, and a copolymer of these are preferred.

In a case where the silanol condensation catalyst is used as a silanol condensation catalyst-containing master batch in which a resin and a silanol condensation catalyst are blended, the content of the silanol condensation catalyst in the master batch is preferably, but not limited to, from 0.1 to 5.0 mass %. Note that a commercially available product may be used as the silanol condensation catalyst-containing master batch, and for example, “PZ010”, available from Mitsubishi Chemical Corporation, can be used.

The resin composition preferably contains an anti-aging agent. When the anti-aging agent is contained, stable extrusion moldability is achieved.

Examples of the anti-aging agent include, but not limited to, a hindered phenol-based antioxidant, a phenol-based antioxidant, an amine-based antioxidant, a phosphorus-based heat stabilizer, a metal deactivator, and a sulfur-based heat resistant stabilizer, and a hindered phenol-based antioxidant is preferred, and a hindered phenol-based antioxidant having a pentaerythritol ester structure is more preferred. Specific examples of the hindered phenol-based antioxidant include IRGANOX (trade name) 1010 (pentaerythritol tetrakis[3-(3,5-di-tert-butyl-4-hydroxyphenyl)propionate]), available from BASF Japan Ltd.

The content of the anti-aging agent is preferably from 1 to 10 parts by mass, more preferably from 2 to 8 parts by mass, and more preferably from 3 to 7 parts by mass, with respect to 100 parts by mass of the rubber.

The resin composition has a tensile strength TB₁₅₀ at 150° C. of preferably 1.5 MPa or more, and more preferably from 1.8 to 30 MPa. To set the tensile strength TB₁₅₀ at 150° C. of the resin composition to the numerical range described above, the degree of crosslinking of the rubber is important.

The water vapor permeability of the resin composition is preferably 3.0 g·mm/(m²·24 h) or less, more preferably 2.5 g mm/(m²·24 h) or less, and even more preferably 2.0 g mm/(m²·24 h) or less. To set the water vapor permeability of the resin composition to the numerical range described above, a rubber having low water vapor permeability and a resin are used.

The 10% modulus M10 at room temperature of the resin composition is preferably 10 MPa or less, more preferably from 0.2 to 9 MPa, and even more preferably from 0.4 to 8 MPa. To set the 10% modulus M10 at room temperature of the resin composition to the numerical range described above, a proportion of the rubber amount in the resin composition is increased.

An aspect of the present technology (II) relates to a method for producing a resin composition containing a matrix containing a resin, and a domain containing a rubber. The production method according to an aspect of the present technology (II) is characterized by including melt-kneading a resin, a rubber, and a rubber crosslinking agent, and in measuring torque over time using an oscillating curemeter when a rubber kneaded material obtained by kneading a rubber and a rubber crosslinking agent is heated at 200° C. and at 230° C. for 10 minutes, torque after 10 minutes at 200° C., S′_{10 min, 200° C.}, is 3.0 dN·m or more, and S′_{10 min, 200° C.}, torque after 10 minutes at 230° C., S′_{10 min, 230° C.}, a maximum value of torque for 0 to 10 minutes at 200° C., S′_{MAX, 200° C.}, and a maximum value of torque for 0 to 10 minutes at 230° C., S′_{MAX, 230° C.}, satisfy: S′_{10 min, 200° C.}/S′_{MAX, 200° C.}≥0.9, and S′_{10 min, 230° C.}/S′_{MAX, 230° C.}≥0.9.

The melt-kneading is not limited but may be performed by using a kneader, a single-screw or twin-screw extruder, or the like.

The temperature during the melt-kneading is not limited as long as the melt-kneading can be performed but is preferably from 170 to 240° C.

The time for the melt-kneading is not limited as long as the target kneaded material can be prepared but is preferably from 2 to 10 minutes.

The melt-kneading is performed by charging the resin, the rubber, the rubber crosslinking agent and, as necessary, various additives such as an anti-aging agent into a kneader or the like.

However, in a case where the resin contains a silane-modified resin and the resin composition contains a silanol condensation catalyst, the silanol condensation catalyst is preferably not added in the melt-kneading process. In a case where the silanol condensation catalyst is added in the melt-kneading process, when the resin composition that has the domain crosslinked and that is prepared in the melt-kneading process is brought into contact with water vapor in the atmosphere, the silane-modified resin in the resin composition gradually crosslinks, and molding of the resin composition after the crosslinking becomes difficult. Therefore, the silanol condensation catalyst is preferably added to the resin composition having the crosslinked domain, during molding.

An aspect of the present technology (III) relates to a refrigerant-transporting hose. The refrigerant-transporting hose of the aspect of the present technology (III) includes an inner layer, a reinforcing layer, and an outer layer, and the outer layer contains the resin composition of the aspect of the present technology (I). By allowing the outer layer to contain the resin composition of the aspect of the present technology (I), a hose having excellent heat resistance and water vapor barrier properties is formed.

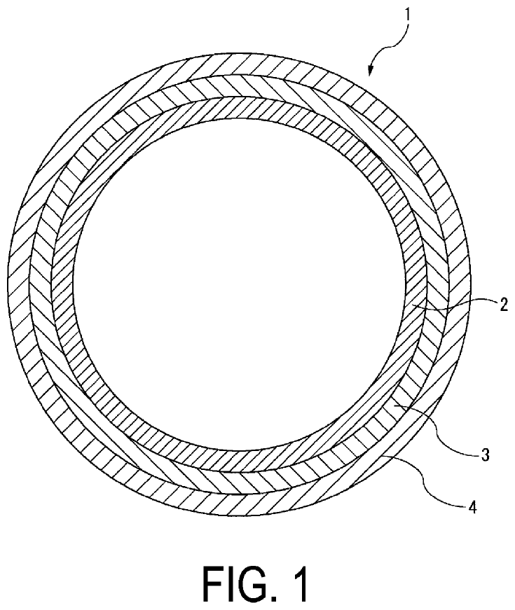

FIG. 1 is a cross-sectional view of a refrigerant-transporting hose of an embodiment. The refrigerant-transporting hose 1 includes an inner layer 2, a reinforcing layer 3 disposed on an outer side of the inner layer 2, and an outer layer 4 disposed on an outer side of the reinforcing layer 3.

The inner layer can be made of, but not limited to, a rubber, a thermoplastic elastomer, a thermoplastic resin composition having a sea-island structure, or the like.

The reinforcing layer, which is not limited, is, for example, a layer of braided fibers.

The reinforcing layer preferably contains, but not limited to, a polyester fiber, a polyamide fiber, an aramid fiber, a PBO fiber, a vinylon fiber, or a rayon fiber.

The method for producing the refrigerant-transporting hose is not particularly limited, and the refrigerant-transporting hose can be produced as follows. First, the inner layer is extruded into a tube shape by extrusion molding, then a fiber which is to serve as a reinforcing layer is braided on the tube, and further the fiber is covered with an outer layer by extrusion molding of the outer layer on the fiber.

### EXAMPLES

### Raw Material

The raw materials used in the following examples and comparative examples are as follows.
IIR: Butyl rubber “Exxon Butyl” 268 (water vapor permeability: 1.5 g·mm/(m²·24 h)), available from ExxonMobil Chemical Company
Br-IIR: Brominated butyl rubber “Exxon Bromobutyl” 2255 (water vapor permeability: 1.6 g mm/(m²·24 h)), available from ExxonMobil Chemical Company
BIMS: Brominated isobutylene-p-methylstyrene copolymer rubber “EXXPRO” (trade name) 3745 (water vapor permeability: 1.4 g·mm/(m²·24 h)), available from ExxonMobil Chemical Company
Rubber crosslinking agent-1: Zinc Oxide III (zinc oxide), available from Seido Chemical Industry Co., Ltd.
Rubber crosslinking agent-2: Alkylphenol-formaldehyde resin “Hitanol” (trade name) 2501Y, available from Hitachi Chemical Co., Ltd.
Rubber crosslinking agent-3: Brominated alkylphenol-formaldehyde resin “TACKIROL” (trade name) 250-I, available from Taoka Chemical Co., Ltd.
NOCCELER TT: Vulcanization accelerator “NOCCELER” (trade name) TT, available from Ouchi Shinko Chemical Industrial Co., Ltd.; substance name: tetramethylthiuram disulfide
Silane-modified resin: Silane-modified polypropylene “Linklon” (trade name) XPM800HM (water vapor permeability: 1.5 g·mm/(m²·24 h)), available from Mitsubishi Chemical Corporation
PP: Propylene homopolymer “Prime Polypro” (trade name) J108M (water vapor permeability: 1.5 g mm/(m²·24 h)), available from Prime Polymer Co., Ltd.
PA11: Nylon 11 “RILSAN” (trade name) BESNO TL (water vapor permeability: 5.4 g·mm/(m²·24 h)), available from Arkema S.A.
PA6: Nylon 6 “UBE Nylon” (trade name) 1011FB (water vapor permeability: 9.2 g mm/(m²·24 h)), available from Ube Industries, Ltd.
Anti-aging agent-1: Hindered phenol-based antioxidant “IRGANOX” (trade name) 1010, available from BASF Japan Ltd.
Anti-aging agent-2: N-phenyl-N′-(1,3-dimethylbutyl)-p-phenylenediamine “SANTOFLEX” (trade name) 6PPD, available from Solutia Inc
Silanol condensation catalyst: Silane crosslinking agent master batch “Catalyst MB” PZ010, available from Mitsubishi Chemical Corporation Examples 1 to 9 and Comparative Examples 1 to 3

The raw materials were charged into a twin-screw extruder (available from The Japan Steel Works, Ltd.) at the compounding ratios listed in Tables 1 to 3, and kneaded for 3 minutes at 235° C. The kneaded product was extruded continuously in a strand-like form from the twin-screw extruder, cooled with water, and then cut with a cutter to obtain a pellet-shaped resin composition.

For Examples and Comparative Examples, S′_{10 min, 200° C.}, S′_{MAX, 200° C.}, S′_{10 min, 230° C.}, and S′_{MAX, 230° C.} were measured. For the obtained resin compositions, water vapor permeability, 10% modulus, and tensile strength at 150° C. were measured. The measurement results are listed in Tables 1 to 3.

The measurement methods for the measurement items were as follows.

### Measurement of Torque

The rubber and the rubber crosslinking agent were kneaded under conditions at 60° C. for 5 minutes by using a kneading machine such as a kneader or a Banbury mixer. The kneaded unvulcanized rubber compound was formed into a 2 to 4 mm sheet by using a pressing machine under a condition at 80° C. The obtained unvulcanized rubber compound pressed sheet was subjected to measurement of maximum values of torque for 0 to 10 minutes, S′_{MAX, 200° C.} and S′_{MAX, 230° C.}, and torque after 10 minutes, S′_{10 min, 200° C.} and S′_{10 min, 230° C.}, which were obtained by heating for 10 minutes at 200° C. and at 230° C., using a strain shear stress analyzer (RPA 2000, available from Alpha Technologies) in accordance with “Determination of cure characteristics with oscillating curemeters” in JIS K 6300-2.

### Measurement of Water Vapor Permeability

A sample of the resin composition or the resin was formed into a sheet with an average thickness of 0.2 mm by using a 40 mm φ single-screw extruder (available from Pla Giken Co., Ltd.) equipped with a 550-mm wide T-shaped die and setting the temperatures of the cylinder and the die at 10° C. plus the melting point of the polymer component having the highest melting point in the sample composition at a cooling roll temperature of 50° C. and a take-up speed of 3 m/min.

A sample of the rubber was formed into a pressed sheet having an average thickness of 0.5 mm by subjecting an unvulcanized rubber compound pressed sheet used for the torque measurement to crosslinking at 200° C. for 10 minutes by a pressing machine.

The obtained sheet was crosslinked by being allowed stand still in the air at a temperature of 25° C. and a relative humidity of 50% for 72 hours, and then measured at a temperature of 60° C. and a relative humidity of 95% using a water vapor permeability tester, available from GTR Tec Corporation.

The water vapor permeability is an indicator of water vapor barrier properties, and a smaller water vapor permeability indicates superior water vapor barrier properties.

### Measurement of 10% Modulus

The crosslinked sheet having an average thickness of 0.2 mm prepared for measurement of the water vapor permeability was punched out into a JIS No. 3 dumbbell shape and subjected to tensile tests in a condition at a temperature of 25° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at 10% elongation (10% modulus) was determined.

The 10% modulus is an indicator of flexibility, and a smaller 10% modulus indicates superior flexibility.

### Measurement of Tensile Strength at 150° C.

The sheet having the average thickness of 0.2 mm produced in the measurement of water vapor permeability was allowed to stand still in the air at a temperature of 25° C. and a relative humidity of 50% for 72 hours or longer, and thus a sheet of the crosslinked resin composition was produced. The sheet of the crosslinked resin composition was punched out into a JIS No. 3 dumbbell shape and subjected to tensile tests in a condition at a temperature of 150° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at break, i.e., tensile strength TB₁₅₀, was determined.

The tensile strength at 150° C. is an indicator of heat resistance, and a higher tensile strength at 150° C. indicates superior heat resistance.

TABLE 1

| | | Example 1 | Example 2 | Example 3 | Example 4 |
|---|---|---|---|---|---|
| IIR | parts by mass | | | | |
| Br-IIR | parts by mass | 100 | 100 | 100 | 100 |
| BIMS | parts by mass | | | | |
| Rubber crosslinking | parts by mass | 6 | 6 | 6 | 6 |
| agent-1 | | | | | |
| Rubber crosslinking | parts by mass | 2 | 2 | | |
| agent-2 | | | | | |
| Rubber crosslinking | parts by mass | | | 9 | 2 |
| agent-3 | | | | | |
| NOCCELLER TT | parts by mass | | | | |
| Silane-modified resin | parts by mass | 21 | 30 | 45 | |
| PP | parts by mass | 21 | 30 | | 39 |
| PA11 | parts by mass | | | | |
| PA6 | parts by mass | | | | |
| Anti-aging agent-1 | parts by mass | 5 | 5 | 5 | 5 |
| Anti-aging agent-2 | parts by mass | | | | |
| Silanol condensation | parts by mass | 2 | 2 | 2 | |
| catalyst | | | | | |
| Water vapor | g · mm/(m² · 24 h) | 1.5 | 1.5 | 1.5 | 1.5 |
| permeability of resin | | | | | |
| Water vapor | g · mm/(m² · 24 h) | 1.6 | 1.6 | 1.6 | 1.6 |
| permeability of rubber | | | | | |
| S′_{10 min, 200 °C} | dN · m | 4.21 | 4.21 | 5.90 | 3.90 |
| S′_{MAX, 200 °C} | dN · m | 4.23 | 4.23 | 5.91 | 3.90 |
| S′_{10 min, 200 °C}/S′_{MAX, 200 °C} | | 1.00 | 1.00 | 1.00 | 1.00 |
| S′_{10 min, 230 °C} | dN · m | 3.39 | 3.39 | 5.04 | 2.89 |
| S′_{MAX, 230 °C} | dN · m | 3.47 | 3.47 | 5.14 | 2.92 |
| S′_{10 min, 230 °C}/S′_{MAX, 230 °C} | | 0.98 | 0.98 | 0.98 | 0.99 |
| Water vapor | g · mm/(m² · 24 h) | 1.5 | 1.5 | 1.4 | 1.4 |
| permeability of | | | | | |
| composition | | | | | |
| 10% modulus | MPa | 6.3 | 9.8 | 6.2 | 4.1 |
| Tensile strength | MPa | 2.3 | 3.2 | 1.8 | 1.5 |
| at 150 °C | | | | | |

TABLE 2

| | | Example 5 | Example 6 | Example 7 | Example 8 |
|---|---|---|---|---|---|
| IIR | parts by mass | 100 | 100 | 100 | |
| Br-IIR | parts by mass | | | | |
| BIMS | parts by mass | | | | 100 |
| Rubber crosslinking | parts by mass | 6 | 6 | 6 | 4 |
| agent-1 | | | | | |
| Rubber crosslinking | parts by mass | 9 | 5 | 5 | |
| agent-2 | | | | | |
| Rubber crosslinking | parts by mass | | | | |
| agent-3 | | | | | |
| NOCCELLER TT | parts by mass | | | | |
| Silane-modified resin | parts by mass | 22 | 21 | 30 | |
| PP | parts by mass | 22 | 21 | 30 | |
| PA11 | parts by mass | | | | 41 |
| PA6 | parts by mass | | | | |
| Anti-aging agent-1 | parts by mass | 5 | 5 | 5 | |
| Anti-aging agent-2 | parts by mass | | | | 3 |
| Silanol condensation | parts by mass | 2 | 2 | 2 | |
| catalyst | | | | | |
| Water vapor | g · mm/(m² · 24 h) | 1.5 | 1.5 | 1.5 | 5.4 |
| permeability of resin | | | | | |
| Water vapor | g · mm/(m² · 24 h) | 1.5 | 1.5 | 1.5 | 1.4 |
| permeability of rubber | | | | | |
| S′_{10 min, 200 °C} | dN · m | 3.96 | 3.25 | 3.25 | 6.56 |
| S′_{MAX, 200 °C} | dN · m | 3.97 | 3.25 | 3.25 | 6.56 |
| S′_{10 min, 200 °C}/S′_{MAX, 200 °C} | | 1.00 | 1.00 | 1.00 | 1.00 |
| S′_{10 min, 230 °C} | dN · m | 3.49 | 2.87 | 2.87 | 6.12 |
| S′_{MAX, 230 °C} | dN · m | 3.49 | 2.87 | 2.87 | 6.12 |
| S′_{10 min, 230 °C}/S′_{MAX, 230 °C} | | 1.00 | 1.00 | 1.00 | 1.00 |
| Water vapor | g · mm/(m² · 24 h) | 1.5 | 1.5 | 1.5 | 2.8 |
| permeability of | | | | | |
| composition | | | | | |
| 10% modulus | MPa | 6.4 | 6.2 | 9.0 | 5.0 |
| Tensile strength | MPa | 2.6 | 2.1 | 3.0 | 7.0 |
| at 150 °C | | | | | |

TABLE 3

| | | Example | Comparative | Comparative | Comparative |
|---|---|---|---|---|---|
| | | 9 | Example 1 | Example 2 | Example 3 |
| IIR | parts by mass | | 100 | | 100 |
| Br-IIR | parts by mass | | | 100 | |
| BIMS | parts by mass | 100 | | | |
| Rubber crosslinking | parts by mass | 4 | 5 | | |
| agent-1 | | | | | |
| Rubber crosslinking | parts by mass | | | 3 | 2 |
| agent-2 | | | | | |
| Rubber crosslinking | parts by mass | | | | |
| agent-3 | | | | | |
| NOCCELLER TT | parts by mass | | 2 | | |
| Silane-modified | parts by mass | | | 20 | 28 |
| resin | | | | | |
| PP | parts by mass | | 40 | 20 | 12 |
| PA11 | parts by mass | | | | |
| PA6 | parts by mass | 60 | | | |
| Anti-aging agent-1 | parts by mass | | 5 | 4 | 4 |
| Anti-aging agent-2 | parts by mass | 3 | | | |
| Silanol condensation | parts by mass | | | | |
| catalyst | | | | | |
| Water vapor | g · mm/(m² · 24 h) | 9.2 | 1.5 | 1.5 | 1.5 |
| permeability of resin | | | | | |
| Water vapor | g · mm/(m² · 24 h) | 1.4 | 1.5 | 1.6 | 1.5 |
| permeability of | | | | | |
| rubber | | | | | |
| S′_{10 min, 200 °C} | dN · m | 6.67 | 2.58 | 3.79 | 2.43 |
| S′_{MAX, 200 °C} | dN · m | 6.67 | 4.69 | 3.83 | 2.44 |
| S′_{10 min, 200 °C}/S′_{MAX, 200 °C} | | 1.00 | 0.55 | 0.99 | 1.00 |
| S′_{10 min, 230 °C} | dN · m | 6.24 | 0.43 | 0.98 | 2.06 |
| S′_{MAX, 230 °C} | dN · m | 6.24 | 3.55 | 2.89 | 2.06 |
| S′_{10 min, 230 °C}/S′_{MAX, 230 °C} | | 1.00 | 0.12 | 0.34 | 1.00 |
| Water vapor | g · mm/(m² · 24 h) | 5.0 | 1.6 | 1.5 | 1.4 |
| permeability of | | | | | |
| composition | | | | | |
| 10% modulus | MPa | 6.5 | 3.7 | 4.5 | 3.0 |
| Tensile strength at | MPa | 20.0 | 0.5 | 0.9 | 0.9 |
| 150 °C | | | | | |

The resin composition according to an embodiment of the present technology can be suitably used as a raw material for producing a refrigerant-transporting hose.

1. A resin composition comprising a matrix and a domain, the matrix comprising a resin, and the domain comprising a rubber; the resin composition comprising a rubber crosslinking agent; and in measuring torque over time using an oscillating curemeter when a rubber kneaded material obtained by kneading the rubber and the rubber crosslinking agent is heated at 200° C. and at 230° C. for 10 minutes, torque S′_{10 min, 200° C.} after 10 minutes at 200° C. being 3.0 dN·m or more, where the torque S′_{10 min, 200° C.}, torque S′_{10 min, 200° C.} after 10 minutes at 230° C.; a maximum torque S′_{MAX, 200° C.} for 0 to 10 minutes at 200° C., and a maximum torque S′_{MAX, 230° C.} for 0 to 10 minutes at 230° C., satisfies: S′_{10 min, 200° C.}/S′_{MAX, 200° C.}≥0.9, and S′_{10 min, 230° C.}/S′_{MAX, 230° C.}≥0.9.

2. The resin composition according to claim 1, wherein a water vapor permeability of the resin is 3.0 g mm/(m²·24 h) or less.

3. The resin composition according to claim 1, wherein a water vapor permeability of the rubber is 3.0 g mm/(m²·24 h) or less.

4. The resin composition according to claim 1, wherein the rubber has a polyisobutylene backbone.

5. The resin composition according to claim 1, wherein the rubber crosslinking agent comprises zinc oxide and an alkylphenol-formaldehyde resin.

6. The resin composition according to claim 1, wherein the resin is a polyolefin resin.

7. The resin composition according to claim 1, wherein-s the resin comprises a silane-modified polyolefin resin.

8. The resin composition according to claim 7, wherein the resin composition comprises a silanol condensation catalyst.

9. The resin composition according to claim 1, wherein a tensile strength at 150° C. of the resin composition is 1.5 MPa or more.

10. The resin composition according to claim 1, wherein a water vapor permeability of the resin composition is 3.0 g mm/(m²·24 h) or less.

11. The resin composition according to claim 1, wherein a 10% modulus of the resin composition at room temperature is 10 MPa or less.

12. A method for producing a resin composition comprising a matrix and a domain, the matrix comprising a resin, and the domain comprising a rubber, the method comprising melt-kneading the resin, the rubber, and a rubber crosslinking agent, and in measuring torque over time using an oscillating curemeter when a rubber kneaded material obtained by kneading the rubber and the rubber crosslinking agent is heated at 200° C. and at 230° C. for 10 minutes, torque S′_{10 min, 200° C.} after 10 minutes at 200° C. being 3.0 dN·m or more, where the torque S′_{10 min, 200° C.}, torque S′_{10 min, 230° C.} after 10 minutes at 230° C., a maximum value of torque S_{MAX, 200° C.} for 0 to 10 minutes at 200° C., and a maximum value of torque S′_{MAX, 230° C.} for 0 to 10 minutes at 230° C. satisfies: S′_{10 min, 200° C.}/S′_{MAX, 200° C.}≥0.9, and S′_{10 min, 230° C.}/S′_{MAX, 230° C.}≥0.9.

13. A refrigerant-transporting hose comprising an inner layer, a reinforcing layer, and an outer layer, the outer layer comprising the resin composition according to claim 1.
